(19) United States
(12) Patent Application Publication
(10) Pub. No.: US 2019/0065032 A1
(43) Pub. Date: Feb. 28, 2019

(54) METHOD AND SYSTEM FOR CAPTURING, STORING, AND RECREATING CURRENT STATE OF AN APPLICATION

(71) Applicant: Lanjia Lin, Foster City, CA (US)

(72) Inventor: Lanjia Lin, Foster City, CA (US)

(21) Appl. No.: 15/684,341

(22) Filed: Aug. 23, 2017

(51) Int. Cl. G06F 3/0484; G06T 1/00; G06F 17/30

(52) U.S. Cl. CPC G06F 3/04842; G06T 1/0007; H04L 51/36; G06F 17/30867; G06F 17/30884

(57) ABSTRACT

A method comprising the steps of initiating and operating an application in a computing system. The computing system being configured for: Capturing a current state of the application, as displayed on a display of the computing system to provide a captured state of the application. Extracting information from the captured state of the application as displayed on the display screen of the computing system, using a designated software program to provide an extracted information. Processing, converting and storing the extracted information to a form that is capable of recreating the current state of the application on the display of the computing system to provide a processed and converted information. Sharing the processed and converted information for recreation and interpretation of the current state of the application.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to sharing status of applications. More particularly, certain embodiments of the invention relate to capturing, storing, recreating and sharing status of applications.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Various applications are known in industry that require sharing information and discussion on complicated software programs. Relying on engineers to flawlessly list the multitude of complicated design requirements item-by-item may not always be efficient.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that some of the software available for sharing the information may typically need the complicated software programs to be available with every user, and may need internet connections to share the information.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary system for sharing status of applications, in accordance with an embodiment of the present invention;

FIG. 2 illustrates an architecture of an exemplary system for sharing status of applications, in accordance with an embodiment of the present invention;

FIG. 3 is a flow chart illustrating an exemplary process for sharing status of applications, in accordance with an embodiment of the present invention;

FIG. 4 is a flow chart illustrating an exemplary process for sharing status of applications, in accordance with an embodiment of the present invention;

FIG. 5 is a flow chart illustrating an exemplary process for sharing status of applications, in accordance with an embodiment of the present invention;

FIG. 6 is a flow chart illustrating an exemplary process sharing status of applications, in accordance with an embodiment of the present invention;

FIG. 7 is a block diagram depicting an exemplary client/server system which may be used by an exemplary web-enabled/networked embodiment of the present invention; and

FIG. 8 illustrates a block diagram depicting a conventional client/server communication system.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

### Terminology

The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

In one embodiment, a system for sharing status of applications is provided. The system described herein may include a designated computer program. In one embodiment, the designated computer program may be capable of capturing a current status of an application. In another embodiment, the designated computer program may be capable of saving the current status of an application in a particular saved format. In one embodiment, the designated computer program may be capable of recreating the current status of an application from the particular saved format. In one embodiment, the designated computer program may be a standalone program that may interact with a target application. In one embodiment, the designated computer program may be program that may be integrated with the target application.

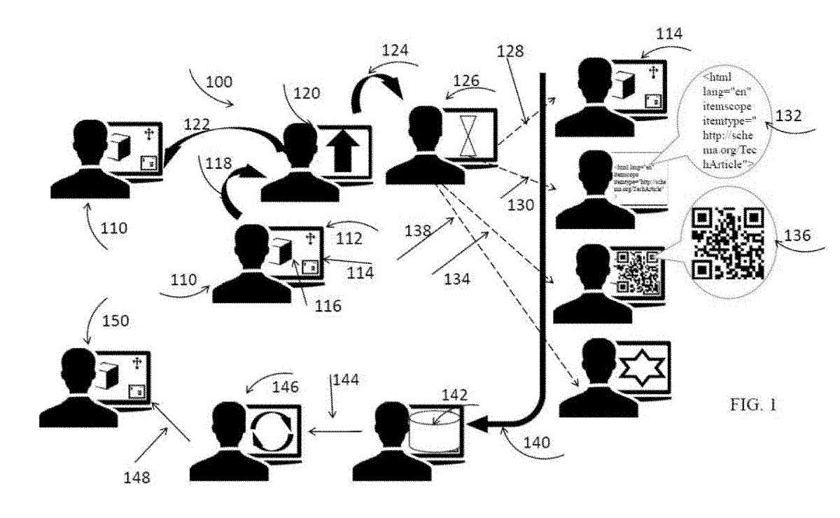

Referring to FIG. 1, is illustrated an exemplary system for sharing status of applications, in accordance with an embodiment of the present invention. The system 100 includes at least a user 110, a computing system 112. The computing system 112 may include a display screen 114, a storage device (not shown in figure), and a graphical input interface. (not shown in figure).

During a typical operation of the system 100 the user 110 may be working on an application 116 (may be at times herein referred to as target tool) in the computer system 112. In one embodiment, the application or target tool may include, but is not limited to, Cadence® Allegro, Mentor Graphics® PADS, EasyEDA (www.easyeda.com), Zeni EDA, KiCad EDA, Altium Designer, FreePCB, ZenitPCB, Synopsys® Silicon Design and the like. It may be appreciated by a person with ordinary skill in the art, in light of and in accordance with the teachings of the present invention, that the target tool may include any application where a user may need to operate to get, view, or check information of any kind of database, where the state of such application manipulation may be necessary for a user to work on like databases. In one exemplary embodiment, the application may include Cadence® Allegro, an application used to develop electronic designs. It may be appreciated by a person with ordinary skill in the art, in light of and in accordance with the teachings of the present invention, that when working with applications like Cadence Allegro, exchanging information regarding some user's Allegro window status may be necessary, for example, if one user wants other user to look at a problem that he/she found, it may not be a straight forward problem, for example, some user may need to describe the setting of an application and the object verbally, and others may need to read the verbal information and manually set the application window, etc. . . . . In exemplary embodiments, the system and process described herein may provide an improved and automatic way for exchanging status information of an application window. This may greatly improve work efficiency for work with Cadence Allegro and similar applications. Accordingly, the user 110 may come across a state of the application, which may be termed as the “current status” of the application. The user 110 may want to themselves or want some other user to revisit the “current status” of the application at a later point in time. In one embodiment, the user 110 may employ the designated computer program to capture 118 the current status of the application. In one embodiment, the user 110 may need to click a “capture” button in the graphical input interface to result in the capture of the current status of the application. It may be appreciated by a person with ordinary skill in the art, in light of and in accordance with the teachings of the present invention, that the “capture” button may be provided to the user in a variety of methods. In one embodiment, the “capture” button may be provided in a physical interface like a keyboard in communication with the computing system 112 in one embodiment. In another embodiment, the “capture” button may be included in the form of an interface link (electronic keyboard) in the display 114 of the computing system 112. In another embodiment, the “capture” button may be included in the form of a link in the application 116 being used by the user. In one exemplary embodiment, as shown in FIG. 1, the “capture” button 120 may be provided on the display screen 114. It may be appreciated by a person with ordinary skill in the art, in light of and in accordance with the teachings of the present invention, that the “capture status, save and restore” features of the designated computer program may be achieved using various sources depending on the target tool.

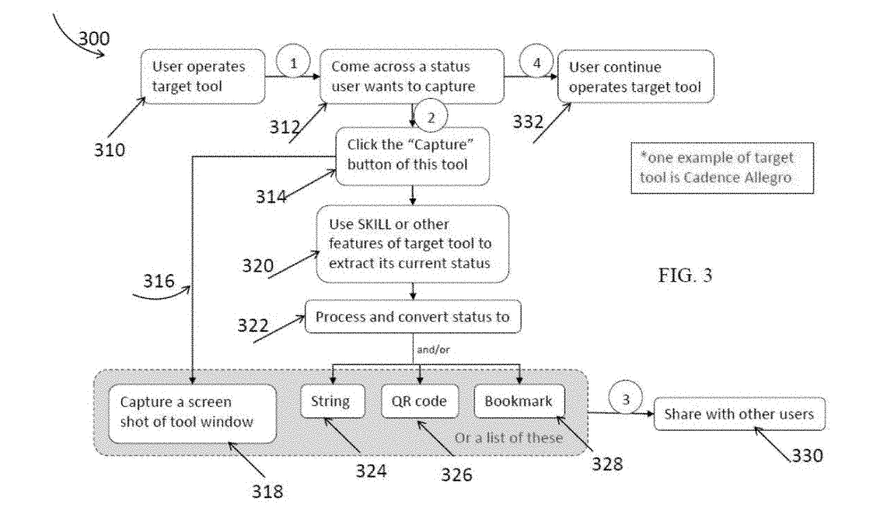

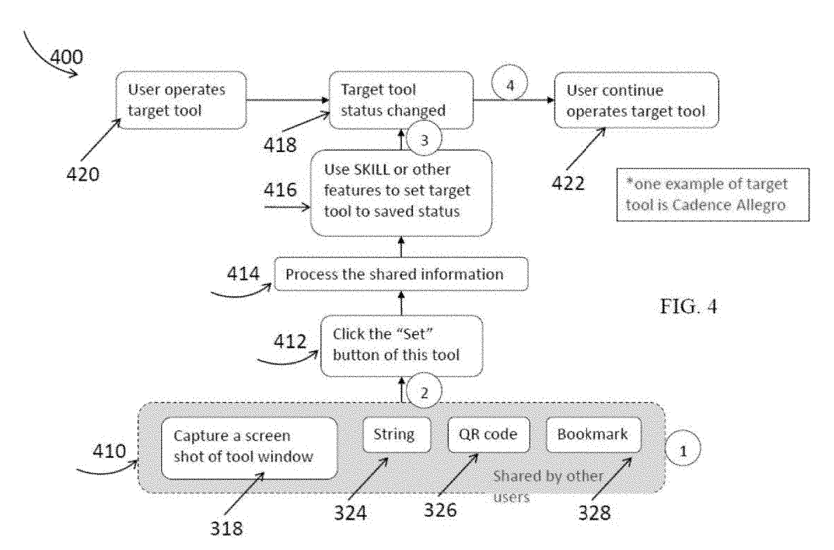

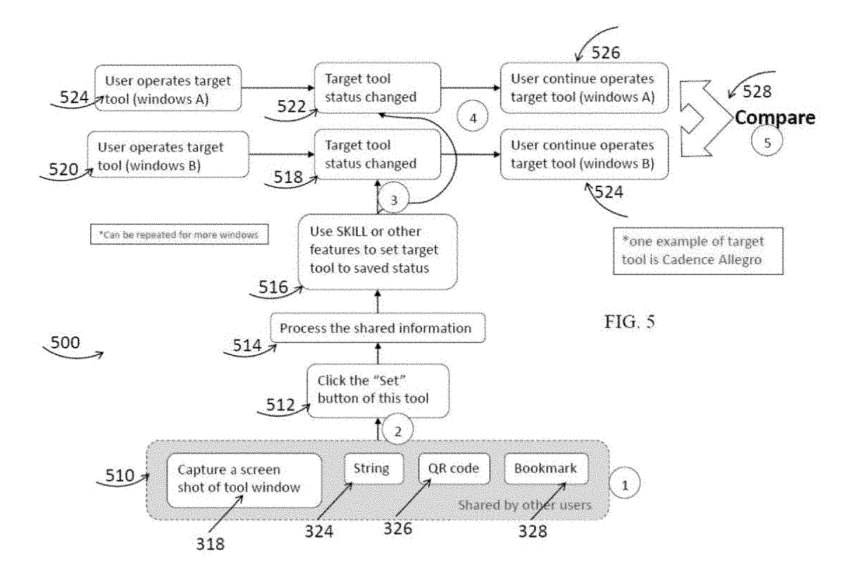

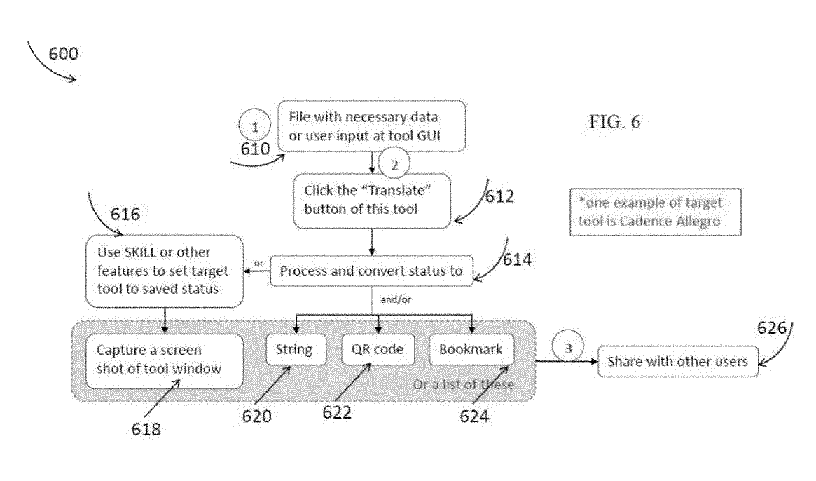

In one embodiment, once the user 110 captures the required current status of the application, the user may resume 122 using the application without any interruption. The designated computer program may then continue 124 with all the steps as described herein in below with reference to FIG. 3, FIG. 4, FIG. 5, and FIG. 6, for example, process all necessary information 126, save all necessary information, such as screen shot 128, string 130 (shown in expanded bubble 132), QR code 134 (shown in expanded bubble 136), bookmark 138, etc. . . . , and store 140 the captured information in a database 142. The user may share 144 the captured information. The captured information may be recreated 146 to obtain 148 the “current status” of the captured information 150 either by the user or by another user with whom the user may share the information. In one embodiment, the user may add and share comments with status information in the captured information. These comments may assist others in understanding the intention/background of the capture and understand the next step action that may be needed with understanding of the capture. The user or other users may revisit the “current status” of the application that was captured. In one embodiment, user actions of sharing of the captured information and the user continuing to use/work the application may be independent actions.

In one embodiment, the graphical input interface provided on the display screen 114 may be used to capture a current status of an application 116. In one embodiment, the current status of an application 116 may include but is not limited to view window range/size/coordinate, displaying setup (layer/feature etc. . . . that may be turned on), target object property (name, type, length, color, highlighted or not), and the like. In some embodiments, the current status of an application 116 may be gathered by the computing system 112 from another device that may have previously gathered and archived/stored the current status of an application. The other device (not shown in figure) may include a computing system similar to or different from that of the computing system 112. In various embodiments, the captured information may be stored in a storage device inbuilt in the computing system, or in an external storage device.

It may be appreciated by a person with ordinary skill in the art, in light of and in accordance with the teachings of the present invention, the computing system 112 may include virtually any computer device capable of capturing, processing, saving, storing, recreating and displaying the captured “current status” of an application. Non-limiting examples of the computing system 112 include a computer, and a smart phone. The computing system 112 may include any computing platform that executes computer software and/or code from a non-transitory computer readable medium. The computing system 112 may include a single device or multiple devices. In embodiments where the computing device 112 is a single device all the functions of capturing, processing, saving, storing, recreating and displaying the captured “current status” of an application, may be executed by the single computer system 112. In embodiments where the computing system 112 includes multiple devices these functions may be distributed between the multiple devices. For example, the capturing, processing, saving, and storing the captured “current status” of an application may be done by one computing system and the recreating and displaying the captured “current status” of an application may be executed by a second device. In another embodiment, the computing system 112 is a single device.

It may be appreciated by a person with ordinary skill in the art, in light of and in accordance with the teachings of the present invention, that the computing system 112 may connect to any number of devices with virtually any wired and/or wireless means. The computing system may connect to virtually any device by means such as, but not limited to, Bluetooth connection, Ethernet cable, USB cable, WIFI, IRDA, etc. . . . . In one embodiment, the computing system 112 may connect to other devices for capturing or processing or saving or storing or recreating or displaying the captured “current status” of an application. In another embodiment, the computing system may connect to other devices for transmitting the captured “current status” of an application.

It may be appreciated by a person with ordinary skill in the art, in light of and in accordance with the teachings of the present invention, that the database may include, but not be limited to, a plurality of data servers, and a memory card. It may be appreciated by a person with ordinary skill in the art, in light of and in accordance with the teachings of the present invention, that the storage device may include a database that stores the information captured and processes on the “current status” of an application 116. In another embodiment, the information captured and processes on the “current status” of an application 116 may be stored in a memory card in the computing system 112.

It may be appreciated by a person with ordinary skill in the art, in light of and in accordance with the teachings of the present invention, the information captured on the “current status” of an application 116 may partially or completely be contained in a local computing platform and/or network. In an alternative embodiment of the present invention, the information captured on the “current status” of an application 116 may be located on a local computer network.

It may be appreciated by a person with ordinary skill in the art, in light of and in accordance with the teachings of the present invention, the storage device may include any portable storage device or the storage device may be internet based. Non-limiting examples of portable storage media include computer readable devices like USB, DVD, etc. . . . . Non-limiting examples of internet based storage media include cloud drive, data download web link, etc. . . . .

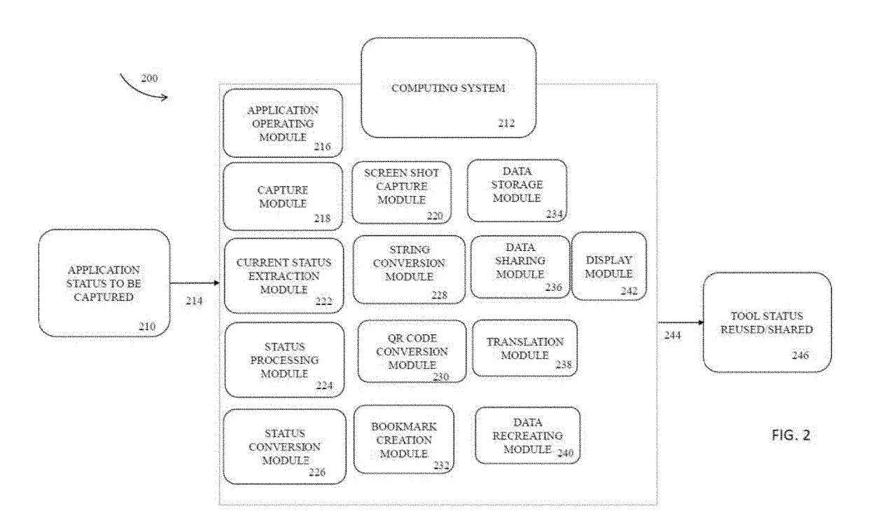

Referring to FIG. 2 is illustrated an architecture of an exemplary system for sharing status of applications, in accordance with an embodiment of the present invention. The architecture 200 may comprise a computing system 212. The computing system 212 includes an application operating module 216, a capture module 218, a screen shot capture module 220, a current status extraction module 222, a status processing module 224, a status conversion module 226, a string conversion module 228, a QR code conversion module 230, a bookmark creation module 232, a data storage module 234, a data sharing module 236, a translation module 238, a data recreating module 240, and a display module 242.

The application operating module 216, may have a means of operating an application, such as, without limitation, a processing unit, a computer, or a server to execute computer code and/or algorithms from a non-transitory computer readable medium, for capturing status of an application 210. The capture module 218, may have a means of capturing 214 a current status 210 of an application, such as, without limitation, a processing unit, a computer, or a server to execute computer code and/or algorithms from a non-transitory computer readable medium, for capturing status of an application 210. The screen shot module 220, may have a means of capturing a screen shot of a “current status” of an application, such as, without limitation, a processing unit, a computer, or a server to execute computer code and/or algorithms from a non-transitory computer readable medium, for capturing status of an application 210. The current status extraction module 222, may have a means of extracting a “current status” of an application where a capture module 218 may have captured the current status of an application, such as, without limitation, a processing unit, a computer, or a server to execute computer code and/or algorithms from a non-transitory computer readable medium, for capturing status of an application 210. The status processing module 224, may have a means of processing a “current status” of an application where a capture module 218 may have captured the current status of an application and a current status extraction module 222 may gave extracted information from the current status of an application, such as, without limitation, a processing unit, a computer, or a server to execute computer code and/or algorithms from a non-transitory computer readable medium, for capturing status of an application 210. The status conversion module 226, may have a means of converting a “current status” of an application such as, without limitation, a processing unit, a computer, or a server to execute computer code and/or algorithms from a non-transitory computer readable medium, for capturing status of an application 210. The string conversion module 228, may have means of converting a “current status” of an application to a string such as, without limitation, a processing unit, a computer, or a server to execute computer code and/or algorithms from a non-transitory computer readable medium, for capturing status of an application 210. The QR code conversion module 230, may have means of converting a “current status” of an application to a QR code such as, without limitation, a processing unit, a computer, or a server to execute computer code and/or algorithms from a non-transitory computer readable medium, for capturing status of an application 210. The bookmark creating module 232, may have means of converting a “current status” of an application to a bookmark such as, without limitation, a processing unit, a computer, or a server to execute computer code and/or algorithms from a non-transitory computer readable medium, for capturing status of an application 210. The data storage module 234 may include a database as described herein above, wherein the database may include, means for storing data on the application, the capture, extraction, processing, conversion, capture, and recreation of the status of the application. The databases may include, but not be limited to, a plurality of data servers, and a memory card. The data sharing module 236, may have means of sharing data on a “current status” of an application such as, without limitation, a processing unit, a computer, or a server to execute computer code and/or algorithms from a non-transitory computer readable medium, for capturing status of an application 210. The translation module 238, may have means of translating converted data on a “current status” of an application which may be in the form of a screen shot, a string, a QR code, a bookmark, and the like forms, such as, without limitation, a processing unit, a computer, or a server to execute computer code and/or algorithms from a non-transitory computer readable medium, for capturing status of an application 210. The data recreating module 240, may have means of recreating translated data on a “current status” of an application which may be in the form of a screen shot, a string, a QR code, a bookmark, and the like forms, such as, without limitation, a processing unit, a computer, or a server to execute computer code and/or algorithms from a non-transitory computer readable medium, for capturing status of an application 210. The display module 242 may have a means to display the current tool status at least in the capturing, converting, and recreating states, such as, without limitation, a screen 114 on a computing system 212, to 244 to a user with whom the tool status is reused/shared 244 (it may include original user or the user with whom information is shared with).

It may be appreciated by a person with ordinary skill in the art, in light of and in accordance with the teachings of the present invention, that one or more modules may be embodied in a single device. In an alternative embodiment of the present invention, all modules except the application operating module and capture module may be embodied in a personal computer or laptop device. The personal computer or laptop device may be capable of extracting, processing, conversion, sharing, translation, and recreating the current status of the application which is captured and transmitted to the personal computer or laptop device.

It may be appreciated by a person with ordinary skill in the art, in light of and in accordance with the teachings of the present invention, that a designated computer program may be used to capture, extract, process, convert, share, translate, and recreate the current status of the application.

It may be appreciated by a person with ordinary skill in the art, in light of and in accordance with the teachings of the present invention, that virtually any algorithm and/or computer code may be used to capture a screen shot, or convert the current status of application to string, QR code, bookmark, and other like formats. It may be appreciated by a person with ordinary skill in the art, in light of and in accordance with the teachings of the present invention, that there may be many methods of capturing a screen shot. These methods may include but are not limited to (i) the “PrtScn” (print screen) key most operating system such as Windows® and Linux® in response to a user using this key input and save the current screen content to an image file as a screen shot; (ii) a few target tools may have their own feature of capturing a screen shot, for example, the “capture image” command in Cadence Allegro® typically saves the screen content to an image file, as a screen shot; (iii) computer programming language such as C++ has a function to save screen content to image file as screen shot; (iv) there are other software, such as ScreenHunter, Screenpresso, and etc, that may be capable of saving screen content to image file. It may be appreciated by a person with ordinary skill in the art, in light of and in accordance with the teachings of the present invention, that there may be a plurality of the same modules in architecture 200 for sharing application status. A plurality of modules such as, without limitation, an application operating module 216, a capture module 218, a screen shot capture module 220, a current status extraction module 222, a status processing module 224, a status conversion module 226, a string conversion module 228, a QR code conversion module 230, a bookmark creation module 232, a data storage module 234, a data sharing module 236, a translation module 238, a data recreating module 240, and a display module 242 may be present in architecture 200 for sharing application status. The plurality of similar modules may work in parallel or independently to improve the throughput and/or speed of architecture 200 for sharing application status. In an alternative embodiment of the present invention, a plurality of capture, extracting, processing, converting, formatting, sharing, translating, recreating, display, and storage modules may be connected for sharing application status system via wired and wireless connections to access resources from different wired and wireless networks. In still another alternative embodiment of the present invention, a plurality of similar modules may form a secondary application status sharing system capable of seamlessly substituting an errant module.

It may be appreciated by a person with ordinary skill in the art, in light of and in accordance with the teachings of the present invention, that one or more modules may transmit capture information to a tech support server that is on an accessible network or over the internet. In an alternative embodiment of the present invention, additional captured information may be sent to a server to alleviate processing load on an application status sharing system, for example, if multiple variations of the applications status are being simultaneously shared.

It may be appreciated by a person with ordinary skill in the art, in light of and in accordance with the teachings of the present invention, that any module in architecture 200 may perform data manipulation. Data manipulation such as, but not limited to, compression, encryption, formatting, etc. . . . . In an alternative embodiment of the present invention, any module sending data may first compress the data prior to data transmission.

Referring to FIG. 3, is provided a flow chart illustrating an exemplary process for sharing status of applications, in accordance with an embodiment of the present invention. In an exemplary embodiment, FIG. 3 provides a process 300 for capturing status of an application or a target tool. In a step 310 a user operates an application or a target tool. In a step 312 the user may come across a status in the application that he/she may want himself/herself/others to revisit later. The user may use a designated computer program to capture the status (“current status” or “current state” as described hereinabove) of the application. In step 314 the user may click the capture button provided in the designated computer program to initiate a capture (in step 316) of the status of the application as displayed on the display 114 of the computer system 112. The designated computer program in the computing system 112 may then capture a screen shot 318 of the “current status” of the application as visible to or as observed by the user on the display 114 of the computing system 112 in step 318. The designated computer program in the computing system may use extraction features of the application SKILL o extract the current status of the application as seen on the display screen in step 320. In step 322 the extracted information may be processed and converted to a string 324, a QR code 326, or a bookmark 328, and the like. As used herein, the term “SKILL” includes a scripting language inside Cadence Allegro. It provides capability to manipulate Cadence Allegro through command line command. It may be appreciated by a person with ordinary skill in the art, in light of and in accordance with the teachings of the present invention, that other target tools may include different scripting languages. In one embodiment, the designated software program may provide the features of allowing a user to save in one or multiple of the methods as disclosed herein. It may be appreciated by a person with ordinary skill in the art, in light of and in accordance with the teachings of the present invention, that a user is the one who may ultimately decide what to store and what to share. A user may decide based on whether one or more of these methods serves the purpose of allowing other users to understand the intention of the capture and understand the next step to be taken with information captured. As mentioned hereinabove, the designated software program may also allow the user to add a comment to the captured information to assist others in understanding the intention of such capture. In step 330 the user may share the information captured by the designated software program with other users. In various embodiments, the user may share the status in particular format, like string, QR code, bookmark, screen shot and the like with other people using a document, an e-mail, text message, etc. . . . . The user with whom the information is shared may use the designated computer program to read and interpret the information sent in the particular format. The application may then be used to set the application window to the same status as shared by the original user, for example, the SKILL programming feature of Allegro may be used to set the application window to the same status as sent by the original sender. This may enable exchange of Allegro window status automatically between one or multiple users.

In one embodiment, in step 332 the user may continue to independently work on the application after clicking the capture button in step 314 without any interruption, as the designated software program captures, processes, and converts the information on the “current status” of the tool indicated for capture by the user in steps 316 to 322. In one embodiment, the capturing process is done by the designated software program, external to the application and may present no interruption to normal use of the application.

Referring to FIG. 4 is provided a flow chart illustrating an exemplary process for sharing status of applications, in accordance with an embodiment of the present invention. In an exemplary embodiment, FIG. 4 provides a process 400 for setting status of the captured “current status” of an application or a target tool as described with reference to FIG. 3 above. The process in FIG. 4 starts with a step 410 where the information shared by a user in the form of captured screen shot of current status of an application in a display screen 318, or a “current status” of an application captured in the form of a string 324, QR code 326, or a bookmark 328 may be revisited by the user or the user with whom the information is shared. Accordingly, in step 410, a user may receive the status information produced by the “capture” process. In one embodiment, the information could be something about the application that the user may capture and store locally, or may be shared by others with the user, or may be shared by the user with others. In step 412 a user or return user may load the status information into the computer system including the designated computer program, and click the “set” button provided by the designated computer program. As described herein above with reference to the “capture” button, in various embodiments, the “set” button may be provided in the graphical input interface that may include the designated computer program, a physical keyboard connected to the computer system, or an electronic key board provided on the display screen of the computer system. In step 414 the shared information is processed by the designated software program in the computer system. In step 416 the designated computer program may use SKILL or other features of the application to “set” the application to the saved status as shared in step 330 of FIG. 3. In step 418 the status of the application is changed/altered to reflect the “current status” captured in step 312 of FIG. 3. Accordingly, the application is now set to the status previously stored by user as shown in FIG. 3. The user now operating the application in step 420 may operate on the changed status of the application 418. The user may continue to operate the application in step 422 on the changed status of the application, i.e., the user will work on the application as if the user is continuing to work on step 312.

Referring to FIG. 5 is provided a flow chart illustrating an exemplary process for sharing status of applications for comparison, in accordance with an embodiment of the present invention. In an exemplary embodiment, FIG. 5 provides a process 500 for setting status of the captured “current status” of an application or a target tool as described with reference to FIG. 3 above for comparing data from different captured “current status” of the application. For example, a user may set multiple application windows of different design versions to same status, which is an easy way to compare design of before/after a change using the process described in FIG. 4. Accordingly, the process in FIG. 5 starts with a step 510 where the information shared by a user in the form of captured screen shot of current status of an application in a display screen 318, or a “current status” of an application captured in the form of a string 324, QR code 326, or a bookmark 328 may be revisited by the user or the user with whom the information is shared. In step 512 a user or return user may click the “set” button provided by the designated computer program. As described herein above with reference to the “capture” button, in various embodiments, the “set” button may be provided in the graphical input interface that may include the designated computer program, a physical keyboard connected to the computer system, or an electronic key board provided on the display screen of the computer system. In step 514 the shared information is processed by the designated software program in the computer system. In step 416 the designated computer program may use SKILL or other features of the application to “set” the application to the saved status as shared in step 330 of FIG. 3. More such “current status” of application may be captured in a manner similar to that described in FIG. 3. In step 518 the status of the application is changed to reflect the “current status” captured in step 312 of FIG. 3. The user now operating the application in step 520 (windows B) may operate on the changed status of the application 518. Another user or the same user may operating in step 524 (window A) may operate with the status of the application changed to reflect the “current status” captured at another point in time and now set in step 522 to reflect changed status in the application. The user(s) may continue to operate the application in step 524 and step 526 based on the changed status of the application in step 518 and 522 respectively. In step 528 the status of the application in step 524 (application being operated by user in Window B) and in step 526 (application being operated by user in window A) may be compared to understand the captured and saved status and may be used to decide the path forward. Accordingly, the designated computer program may set status on multiple target tool windows i.e., window A and window B. The different application windows may open different versions of a project, therefore the result of step 522 and 518 will make these windows show only the difference in version, which may then be compared in step 528. In one embodiment, the designated computer program may allow a user to control which application windows to set to saved status, when multiple application windows are opened. In another embodiment, the designated computer program may allow user to set status on all or one of the application windows.

Referring to FIG. 6 is provided a flow chart illustrating an exemplary process for sharing status of applications, in accordance with an embodiment of the present invention. In an exemplary embodiment, FIG. 6 provides a process 600 for translating status of the captured “current status” of an application or a target tool as described with reference to FIG. 3 above. The process in FIG. 6 i.e., the “Translation” flow is similar to the “Capture” flow shown in FIG. 3. In one embodiment, the difference between the translation flow 600 and the capture flow 300, is that in translation flow, the user may not need to interact with the application or target tool. The translation flow 600 may be used by advanced users who may have knowledge of the application status information. The translation flow 600 may provide a way for users to “make up” for missed or lost status information. Such status information, if everything checks out, may work in the same way as the status information captured directly from the target tool in FIG. 3. The translation flow process 600 starts with a step 610 where the file with necessary data or user input on the “captured status” or user input is available at the graphical user interface GUI of the designated computer program in the computer system. In step 613 the user may click on the “translate” button of the designated software program. As described herein above with reference to the “capture” button, in various embodiments, the “translate” button may be provided in the graphical input interface that may include the designated computer program, a physical keyboard connected to the computer system, or an electronic key board provided on the display screen of the computer system. In one embodiment, in step 614 the shared information is processed and converted by the designated software program in the computer system to a string 620, QR code 622, or bookmark 624. Alternatively, in step 616 the designated computer program may use SKILL or other features of the application to “set” the application to the saved status in the application display and capture a screen shot 618 of the application as displayed in display 114 of the computer system 112. In step 626 the screen shot, sting, QR code, bookmark, etc. . . . , may be shared with other users.

In one embodiment, the system and process for sharing information on an application status described herein may have the following advantages, including but not limited to, (i) easier sharing and discussing using the application among group members; (ii) improved efficiency in operating the application; and (iii) physical bookmarking of important status of application during design process, etc. . . . . In one embodiment, the system and process described herein provides for capturing the state of applications, saving the state of application, and later recreating the saved status of the applications and there may be minimal or no risk of altering the database/content while the application is being edited. In another embodiment, the system and process described herein provides for converting the captured state of applications to a string through encoding, convert such string to QR code, etc. . . . which may make it easier for sharing with other users. In another embodiment, the system and process described herein provides a user with being able to work with multiple application windows, allow full control of what to capture, which screen to set status, etc. . . . .

In one embodiment, the system and process described herein may provide a customized rich text editor or like feature. The rich text editor that may help format the captured content for easier sharing/commenting with other users. i.e., the rich text editor may allow a user to save the screen shot of an application window, save the QR code, add comment on saved status, and track comment enter by other users, save content to local file for record or sharing, etc. . . . .

In one embodiment, the system and process described herein may be enabled to take different forms of input for the captured application status string (encoded), such as, camera reading of QR code, manual input of string, QR code display on screen, and the like. Accordingly, the designated computer program may include functions to format captured information, such as screen shot, QR code, string, etc. . . . . Furthermore, to restore status of application as described in FIG. 4, the designated software program may be capable of interacting with a camera and like devices to read the QR code to obtain status content. The user is thus enabled to use a paper print of the current status of captured application document and not rely solely on an electronic copy. Furthermore, the designated software program may be capable of accepting a string input manually if the user provides a manual input instead of an electronic input.

In one embodiment, the designated software program may be enabled only to alter the status of the application, such as view setting, feature setting, etc. . . . , and may not be enabled to make any change to the design data the application may be operating on. Change to design database may be done by a user as the designated software program may only set the application to a desire state for user operation. This may prevent any unintentional changes to the actual application under the operation of designated software program.

In various embodiments, the system and process for sharing status of applications may have multiple uses. For example, with reference to an application or target tool like Cadence® Allegro, when a user may need to navigate away from a current task to work on a higher priority one, the user may need to memorize or take note of the current status of Allegro application (layer, x-y coordinate, net name, feature that is on, etc.) in order to get back to the original task later. Using the system and process described herein the user may click one button to capture and save the current status, after navigating away, user just needs to click another button and the Allegro application will be set to exactly the same as the original status and user can resume original task right away instead of taking multiple actions to set Allegro back to original status to continue original task. In one embodiment, the designated computer program incorporating the “capture status, save and restore” feature may be a standalone program that may interact with Allegro application. In one embodiment, the designated computer program may be program that may be integrated with Allegro application and the “capture status, save and restore” feature may be a part of the Allegro application.

For example, consider a presenter making a live presentation using the Allegro application to show different aspects of the design database, and each aspect may require to set Allegro in a certain way for better view. Using the system and process described herein, the presenter may create a series of bookmarks before the presentation for each aspect, and then during the presentation one button click may set the Allegro application window for the target aspect instead of the presenter memorizing or taking notes of each aspect, and pausing and setting the Allegro application during any meeting for showing the different aspects.

For example, when one user may want another user to look at a instance in a design database, the user may need to verbally describe such instance (layer, x-y coordinate, net name, feature that is on, etc. . . . ), upon receiving that information, other users may need to take multiple action to set Allegro to replicate such instance. Using the system and process described herein, the user may just click one button and capture the status of such instance, then send the string/QR code/bookmark to others and others just need one button click to set their design application i.e., Allegro to show that instance.

For example, when a change to a design database is requested, sometimes it is necessary to compare such change before and after the change is made. This may require opening two or more Allegro windows (each showing a different version of the design database) and set each to same state for comparison. Using the system and process described herein, one button click can set all Allegro windows to exactly the same state, making comparing them a breeze instead of manually setting up each window to a comparable state.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

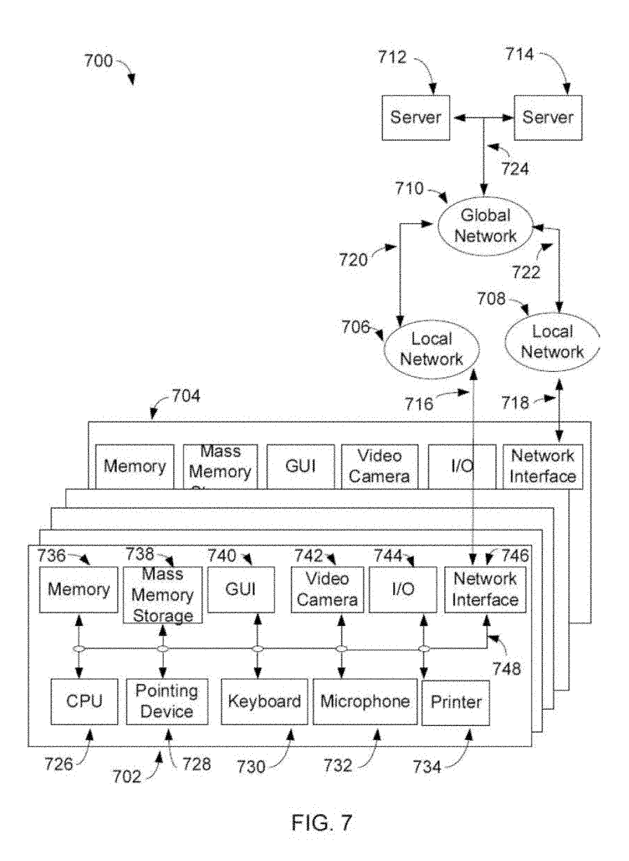

FIG. 7 is a block diagram depicting an exemplary client/server system which may be used by an exemplary web-enabled/networked embodiment of the present invention.

A communication system 700 includes a multiplicity of clients with a sampling of clients denoted as a client 702 and a client 704, a multiplicity of local networks with a sampling of networks denoted as a local network 706 and a local network 708, a global network 710 and a multiplicity of servers with a sampling of servers denoted as a server 712 and a server 714.

Client 702 may communicate bi-directionally with local network 706 via a communication channel 716. Client 704 may communicate bi-directionally with local network 708 via a communication channel 718. Local network 706 may communicate bi-directionally with global network 710 via a communication channel 720. Local network 708 may communicate bi-directionally with global network 710 via a communication channel 722. Global network 710 may communicate bi-directionally with server 712 and server 714 via a communication channel 724. Server 712 and server 714 may communicate bi-directionally with each other via communication channel 724. Furthermore, clients 702, 704, local networks 706, 708, global network 710 and servers 712, 714 may each communicate bi-directionally with each other.

In one embodiment, global network 710 may operate as the Internet. It will be understood by those skilled in the art that communication system 700 may take many different forms. Non-limiting examples of forms for communication system 700 include local area networks (LANs), wide area networks (WANs), wired telephone networks, wireless networks, or any other network supporting data communication between respective entities.

Clients 702 and 704 may take many different forms. Non-limiting examples of clients 702 and 704 include personal computers, personal digital assistants (PDAs), cellular phones and smartphones.

Client 702 includes a CPU 726, a pointing device 728, a keyboard 730, a microphone 732, a printer 734, a memory 736, a mass memory storage 738, a GUI 740, a video camera 742, an input/output interface 744, and a network interface 746.

CPU 726, pointing device 728, keyboard 730, microphone 732, printer 734, memory 736, mass memory storage 738, GUI 740, video camera 742, input/output interface 744 and network interface 746 may communicate in a unidirectional manner or a bi-directional manner with each other via a communication channel 748. Communication channel 748 may be configured as a single communication channel or a multiplicity of communication channels.

CPU 726 may be comprised of a single processor or multiple processors. CPU 726 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 736 is used typically to transfer data and instructions to CPU 726 in a bi-directional manner. Memory 736, as discussed previously, may include any suitable computer-readable media, intended for data storage, such as those described above excluding any wired or wireless transmissions unless specifically noted. Mass memory storage 738 may also be coupled bi-directionally to CPU 726 and provides additional data storage capacity and may include any of the computer-readable media described above. Mass memory storage 738 may be used to store programs, data and the like and is typically a secondary storage medium such as a hard disk. It will be appreciated that the information retained within mass memory storage 738, may, in appropriate cases, be incorporated in standard fashion as part of memory 736 as virtual memory.

CPU 726 may be coupled to GUI 740. GUI 740 enables a user to view the operation of computer operating system and software. CPU 726 may be coupled to pointing device 728. Non-limiting examples of pointing device 728 include computer mouse, trackball and touchpad. Pointing device 728 enables a user with the capability to maneuver a computer cursor about the viewing area of GUI 740 and select areas or features in the viewing area of GUI 740. CPU 726 may be coupled to keyboard 730. Keyboard 730 enables a user with the capability to input alphanumeric textual information to CPU 726. CPU 726 may be coupled to microphone 732. Microphone 732 enables audio produced by a user to be recorded, processed and communicated by CPU 726. CPU 726 may be connected to printer 734. Printer 734 enables a user with the capability to print information to a sheet of paper. CPU 726 may be connected to video camera 742. Video camera 742 enables video produced or captured by user to be recorded, processed and communicated by CPU 726.

CPU 726 may also be coupled to input/output interface 744 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 726 optionally may be coupled to network interface 746 which enables communication with an external device such as a database or a computer or telecommunications or internet network using an external connection shown generally as communication channel 716, which may be implemented as a hardwired or wireless communications link using suitable conventional technologies. With such a connection, CPU 726 might receive information from the network, or might output information to a network in the course of performing the method steps described in the teachings of the present invention.

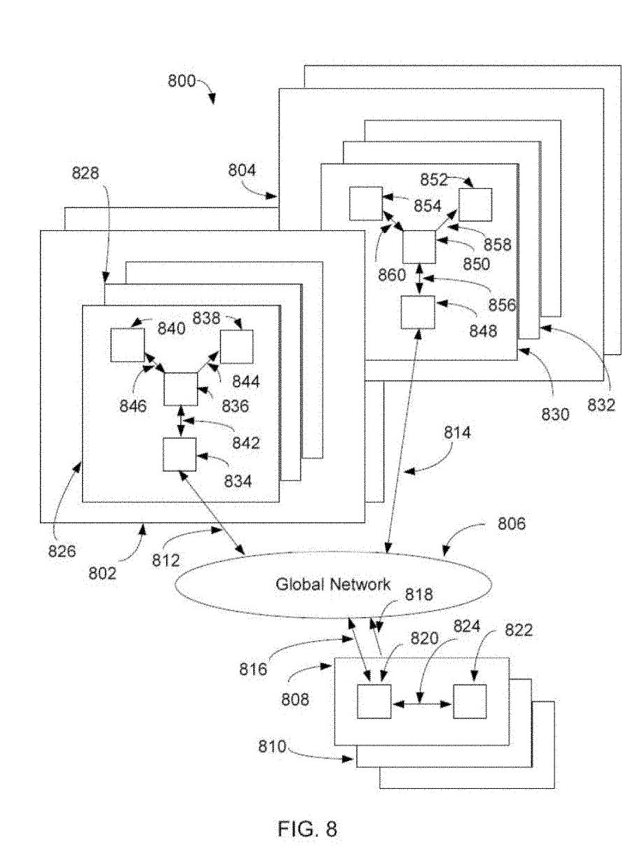

FIG. 8. illustrates a block diagram depicting a conventional client/server communication system.

A communication system 800 includes a multiplicity of networked regions with a sampling of regions denoted as a network region 802 and a network region 804, a global network 806 and a multiplicity of servers with a sampling of servers denoted as a server device 808 and a server device 810.

Network region 802 and network region 804 may operate to represent a network contained within a geographical area or region. Non-limiting examples of representations for the geographical areas for the networked regions may include postal zip codes, telephone area codes, states, counties, cities and countries. Elements within network region 802 and 804 may operate to communicate with external elements within other networked regions or within elements contained within the same network region.

In some implementations, global network 806 may operate as the Internet. It will be understood by those skilled in the art that communication system 800 may take many different forms. Non-limiting examples of forms for communication system 800 include local area networks (LANs), wide area networks (WANs), wired telephone networks, cellular telephone networks or any other network supporting data communication between respective entities via hardwired or wireless communication networks. Global network 806 may operate to transfer information between the various networked elements.

Server device 808 and server device 810 may operate to execute software instructions, store information, support database operations and communicate with other networked elements. Non-limiting examples of software and scripting languages which may be executed on server device 808 and server device 810 include C, C++, C# and Java.

Network region 802 may operate to communicate bi-directionally with global network 806 via a communication channel 812. Network region 804 may operate to communicate bi-directionally with global network 806 via a communication channel 814. Server device 808 may operate to communicate bi-directionally with global network 806 via a communication channel 816. Server device 810 may operate to communicate bi-directionally with global network 806 via a communication channel 818. Network region 802 and 804, global network 806 and server devices 808 and 810 may operate to communicate with each other and with every other networked device located within communication system 800.

Server device 808 includes a networking device 820 and a server 822. Networking device 820 may operate to communicate bi-directionally with global network 806 via communication channel 816 and with server 822 via a communication channel 824. Server 822 may operate to execute software instructions and store information.

Network region 802 includes a multiplicity of clients with a sampling denoted as a client 826 and a client 828. Client 826 includes a networking device 834, a processor 836, a GUI 838 and an interface device 840. Non-limiting examples of devices for GUI 838 include monitors, televisions, cellular telephones, smartphones and PDAs (Personal Digital Assistants). Non-limiting examples of interface device 840 include pointing device, mouse, trackball, scanner and printer. Networking device 834 may communicate bi-directionally with global network 806 via communication channel 812 and with processor 836 via a communication channel 842. GUI 838 may receive information from processor 836 via a communication channel 844 for presentation to a user for viewing. Interface device 840 may operate to send control information to processor 836 and to receive information from processor 836 via a communication channel 846. Network region 804 includes a multiplicity of clients with a sampling denoted as a client 830 and a client 832. Client 830 includes a networking device 848, a processor 850, a GUI 852 and an interface device 854. Non-limiting examples of devices for GUI 838 include monitors, televisions, cellular telephones, smartphones and PDAs (Personal Digital Assistants). Non-limiting examples of interface device 840 include pointing devices, mousse, trackballs, scanners and printers. Networking device 848 may communicate bi-directionally with global network 806 via communication channel 814 and with processor 850 via a communication channel 856. GUI 852 may receive information from processor 850 via a communication channel 858 for presentation to a user for viewing. Interface device 854 may operate to send control information to processor 850 and to receive information from processor 850 via a communication channel 860.

For example, consider the case where a user interfacing with client 826 may want to execute a networked application. A user may enter the IP (Internet Protocol) address for the networked application using interface device 840. The IP address information may be communicated to processor 836 via communication channel 846. Processor 836 may then communicate the IP address information to networking device 834 via communication channel 842. Networking device 834 may then communicate the IP address information to global network 806 via communication channel 812. Global network 806 may then communicate the IP address information to networking device 820 of server device 808 via communication channel 816. Networking device 820 may then communicate the IP address information to server 822 via communication channel 824. Server 822 may receive the IP address information and after processing the IP address information may communicate return information to networking device 820 via communication channel 824. Networking device 820 may communicate the return information to global network 806 via communication channel 816. Global network 806 may communicate the return information to networking device 834 via communication channel 812. Networking device 834 may communicate the return information to processor 836 via communication channel 842. Processor 846 may communicate the return information to GUI 838 via communication channel 844. User may then view the return information on GUI 838.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC § 112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6). It is noted that according to USA law, all claims must be set forth as a coherent, cooperating set of limitations that work in functional combination to achieve a useful result as a whole. Accordingly, for any claim having functional limitations interpreted under 35 USC § 112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6) is/(are) dependent on one or more remote servers located outside the USA, it is intended that each such recited function under 35 USC § 112 (6) is to be interpreted as the function of the local system receiving the remotely generated information required by a locally implemented claim limitation, wherein the structures and or steps which enable, and breath life into the expression of such functions claimed under 35 USC § 112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC § 112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of sharing status of applications according to the present invention will be apparent to those skilled in the art. Various aspects of the invention have been described above by way of illustration, and the specific embodiments disclosed are not intended to limit the invention to the particular forms disclosed. The particular implementation of the sharing of status of applications may vary depending upon the particular context or application. By way of example, and not limitation, the sharing of status of applications described in the foregoing were principally directed to design softwares like Cadence® Allegro implementations; however, similar techniques may instead be applied to any application where a user may need to operate to get, view, or check information of any kind of database, where the state of such application manipulation may be necessary for a user to work on like databases, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

1. A method comprising the steps of:
initiating and operating an application in a computing system, the computing system being configured for:
capturing a current state of the application, as displayed on a display of the computing system to provide a captured state of the application;
extracting information from the captured state of the application as displayed on the display screen of the computing system, using a designated software program to provide an extracted information;
processing, converting and storing the extracted information to a form that is capable of recreating the current state of the application on the display of the computing system to provide a processed and converted information; and
sharing the processed and converted information for recreation and interpretation of the current state of the application.

2. The method of claim 1, wherein the application comprises an application wherein there is a need to operate, to get, view, or check information of any kind of database, and wherein the current state of the application manipulation is necessary for work.

3. The method of claim 1, wherein the application is a design tool.

4. The method of claim 1, wherein the capturing of the current state of the application is done using a capture button in the computing system.

5. The method of claim 4, wherein the capture button is a print screen button on a graphical user interface in the computing system.

6. The method of claim 1, wherein the extracting of the current state of the application is done using a scripting language in the application.

7. The method of claim 1, wherein the form that is capable of recreating the current state of the application comprises a string, a QR code, or a bookmark.

8. The method of claim 1, wherein the sharing of the processed and converted information comprises using a document, an e-mail, a text message, and the like.

9. The method of claim 1, wherein the computing system is configured to continue working on the same application or other application once the capture button is activated, and the steps of capturing, extracting, processing, converting, and storing is carried in the background by the designated software program in the computing system.

10. The method of claim 1, wherein the computing system is configured to set the display of the display screen of the computing system to the captured state of the application.

11. A method comprising:
steps for initiating and operating an application on at least one computing system;
steps for capturing a current state of the application, as displayed on a display of the computing system to provide a captured state of the application;
steps for extracting information from the captured state of the application as displayed on the display screen of the computing system, using a designated software program to provide an extracted information;
steps for processing, converting, and storing the extracted information to a form that is capable of recreating the current state of the application on the display of the computing system to provide a processed and converted information; and
steps for sharing the processed and converted information for recreation and interpretation of the current state of the application

12. The method of claim 11, wherein the application comprises an application wherein there is a need to operate, to get, view, or check information of any kind of database, and wherein the current state of the application manipulation is necessary for work.

13. The method of claim 11, wherein the application is a design tool.

14. The method of claim 11, wherein the capturing of the current state of the application is done using a capture button in the computing system.

15. The method of claim 11, wherein the extracting of the current state of the application is done using a scripting language in the application.

16. The method of claim 11, wherein the computing system is configured to continue working on the same application or other application once the capture button is activated, and the steps of capturing, extracting, processing, converting, and storing is carried in the background by the designated software program in the computing system.

17. A non-transitory computer-readable storage medium with an executable program stored thereon, wherein the program instructs one or more processors to perform the following steps:
initiating and operating an application in a computing system, the computing system being configured for:
capturing a current state of the application, as displayed on a display of the computing system to provide a captured state of the application;
extracting information from the captured state of the application as displayed on the display screen of the computing system to provide an extracted information;
processing, converting, and storing the extracted information to a form that is capable of recreating the current state of the application on the display of the computing system to provide a processed and converted information; and
sharing the processed and converted information for recreation and interpretation of the current state of the application.

18. The method of claim 17, wherein the capturing of the current state of the application is done using a capture button in the computing system.

19. The method of claim 17, wherein the extracting of the current state of the application is done using a scripting language in the application.

20. The method of claim 17, wherein the computing system is configured to continue working on the same application or other application once the capture button is activated, and the steps of capturing, extracting, processing, converting, and storing is carried in the background by the designated software program in the computing system.
